(19) United States
(12) Patent Application Publication
(10) Pub. No.: US 2025/0389293 A1
(43) Pub. Date: Dec. 25, 2025

(54) WOOD SCREW

(71) Applicant: THE HILLMAN GROUP, INC., Cincinnati, OH (US)

(72) Inventors: Dale G. MALOTT, Gilbert, AZ (US); Farhad LAJEWARDI, Toronto (CA)

(21) Appl. No.: 19/307,828

(22) Filed: Aug. 22, 2025

Related U.S. Application Data
(62) Division of application No. 18/185,794, filed on Mar. 17, 2023.
Application No. 18/185,794 is a continuation-in-part of application No. 17/699,536, filed on Mar. 21, 2022, now Pat. No. 12,085,107.
(60) Provisional application No. 63/167,809, filed on Mar. 30, 2021.
(60) Provisional application No. 63/321,895, filed on Mar. 21, 2022.

(51) Int. Cl. F16B 25/00

(52) U.S. Cl. CPC F16B 25/0015; F16B 25/0052; F16B 25/0068

(57) ABSTRACT

A screw includes a head end, a shank and a tapered end, the head end including a tool engaging part, the shank having a central axis, the head end located at a first end of the shank and the tapered end located at a second end of the shank. A thread is formed along the shank, begins on the tapered end, extends onto the shank and toward the head end. The head end includes a neck running from the first end of the shank to a head cap, wherein the head cap includes an underside facing the tapered end and defining an annular ledge, wherein the annular ledge faces the tapered end. The neck includes a first frustoconical segment running from the shank to an axial location spaced from the annular ledge, wherein the neck includes a second frustoconical segment running from the annular ledge toward the axial location.

### TECHNICAL FIELD

This application relates generally to threaded fasteners and, more particularly, to a wood screw for use in decking and similar applications.

### BACKGROUND

A typical screw configuration includes an elongated shank that extends between a driving head of the screw and a pointed end of the screw. At least part of the shank is helically threaded. Contractors installing wood screws regularly encounter issues with excessive torque required to install, which requires more work by the operator and reduces battery life in the case of battery powered screw guns. Contractors also seek the ability to reduce the time needed to drive such screws. In addition, improved performance in wood screws is regularly sought, including pull through performance and thread strength.

It would be desirable to provide a wood screw configuration that addresses one or more of such issues.

### SUMMARY

In one aspect, a wood screw includes a head end, a shank and a tapered end, the head end including a tool engaging part, the head end located at a first end of the shank and the tapered end located at a second end of the shank. A thread is formed along the shank, wherein the thread begins on the tapered end, extends onto the shank and terminates at a first axial location along the shank that is spaced from the head end. A reaming section is located along the shank and running from proximate to the first axial location and toward the head end, the reaming section including projections thereon, wherein the reaming section comprises a first segment with a repeating pattern of rotationally leading wedge projections and rotationally trailing wedge projections.

In another aspect, a wood screw includes a head end, a shank and a tapered end, the head end including a tool engaging part, the head end located at a first end of the shank and the tapered end located at a second end of the shank. A thread is formed along the shank, wherein the thread begins on the tapered end, extends onto the shank and toward the head end. The head end includes a neck running from the first end of the shank to a head cap, wherein the head cap includes an underside facing the tapered end, wherein the underside includes a plurality of serrations extending around the underside, each serration having a leading face and a trailing face that define a cutting edge, wherein the trailing face of each serration tapers away from the tapered end.

In a further aspect, a wood screw includes a head end, a shank and a tapered end, the head end including a tool engaging part, the head end located at a first end of the shank and the tapered end located at a second end of the shank. A thread is formed along the shank, wherein the thread begins on the tapered end, extends onto the shank and toward the head end. The thread includes a peripheral edge, and an initial axial segment comprising multiple thread turns and along which the peripheral edge includes a plurality of notches, and a following axial segment comprising multiple thread turns and along which the peripheral edge lacks any notches, wherein the plurality of notches along the initial axial segment includes first notches having a first radial depth and second notches having a second radial depth that is less than the first radial depth.

In another aspect, a wood screw includes a head end, a shank and a tapered end, the head end including a tool engaging part, the head end located at a first end of the shank and the tapered end located at a second end of the shank. A thread is formed along the shank, wherein the thread begins on the tapered end, extends onto the shank and toward the head end. The thread is a dual start thread formed by a first thread and a second thread, wherein the first thread begins on the tapered end and the second thread begins on the tapered end, wherein the second thread begins on the tapered end and is rotationally offset from the first thread by one-hundred eighty degrees.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 shows a side elevation view of one embodiment of a wood screw;

FIG. 2 shows a perspective view of the screw;

FIGS. 3 and 4 show partial side elevation views of the screw;

FIGS. 5A and 5B show alternative exemplary cross-sections taken along the tapered end of the screw, and looking toward the head end of the screw, in planes perpendicular to the axis of the screw;

FIG. 6 shows a partial side elevation view of the screw;

FIG. 7 shows a cross-section of a thread segment of the screw taken along a plane in which the screw axis lies;

FIGS. 8A and 8B show cross-sections taken along the shank of the screw, and looking toward the head end of the screw, in a plane that is offset from perpendicular to the axis of the screw;

FIGS. 9-13 show views of the head end of the screw;

FIGS. 14A and 14B show a reaming section of the screw;

FIGS. 15A and 15B show respective alternative embodiments of the first segment of the reaming section;

FIG. 16 shows a further alternative embodiment of the reaming section;

FIGS. 17, 17A and 18-20 shows further alternative embodiments of the reaming section;

FIGS. 21A-21B show a screw embodiment without a reaming section;

FIG. 22 shows a potential alternative head configuration in which the serrations at the underside of the head join with each other;

FIGS. 23-31 and 33-34 show another embodiment of a screw; and

FIG. 32 shows an alternative reaming section configuration.

### DETAILED DESCRIPTION

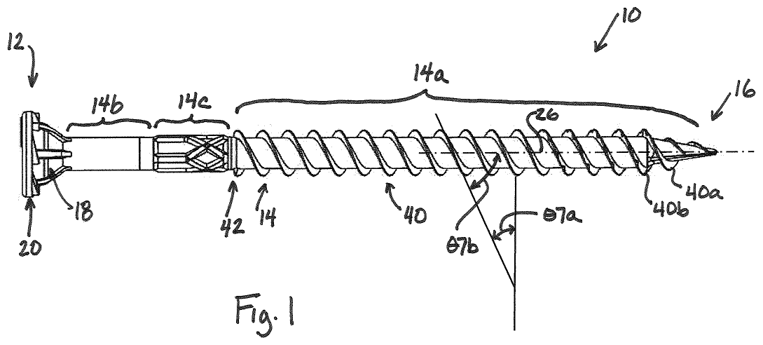

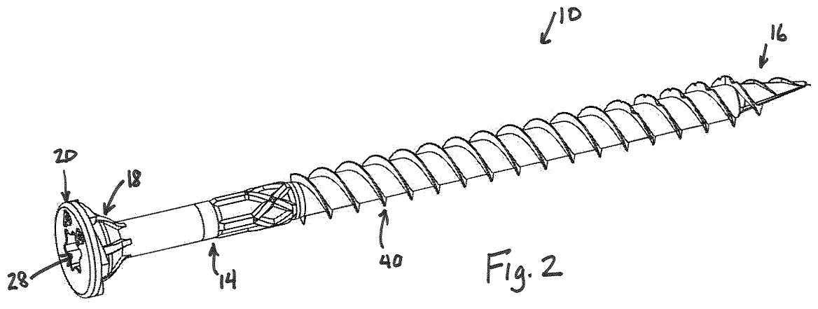

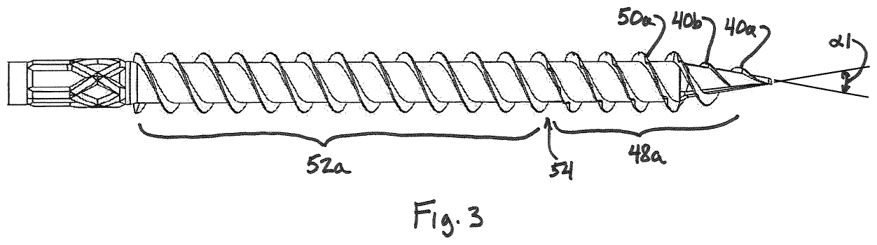

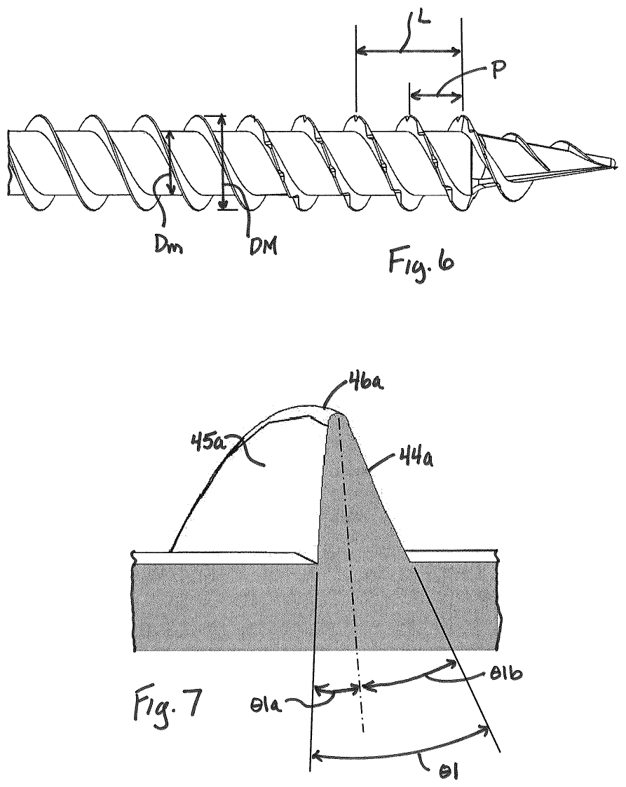

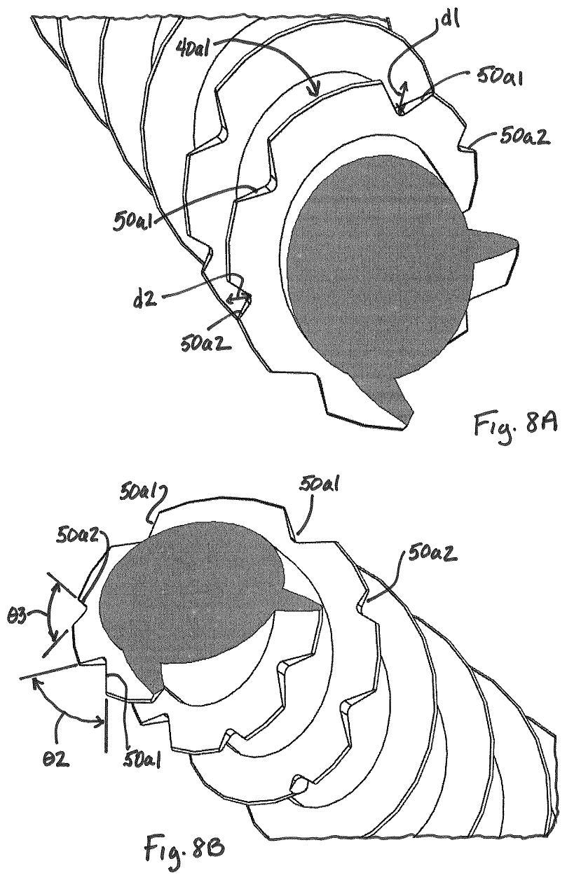

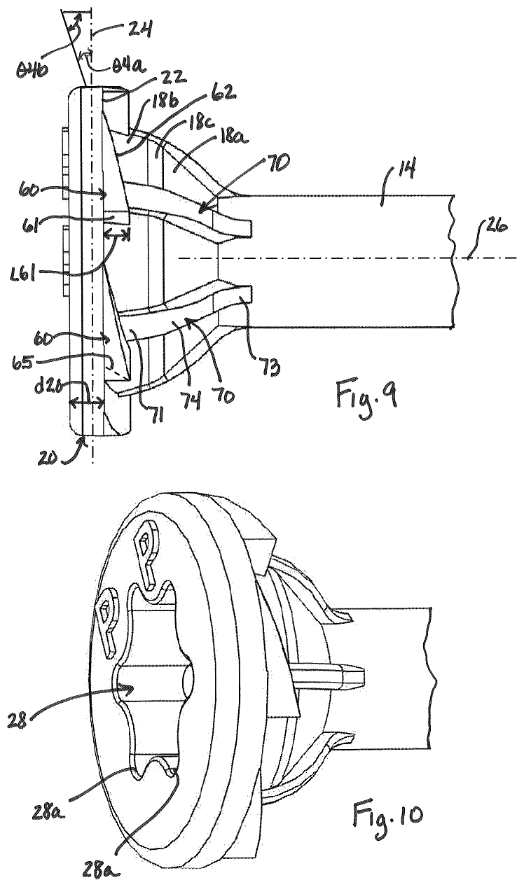

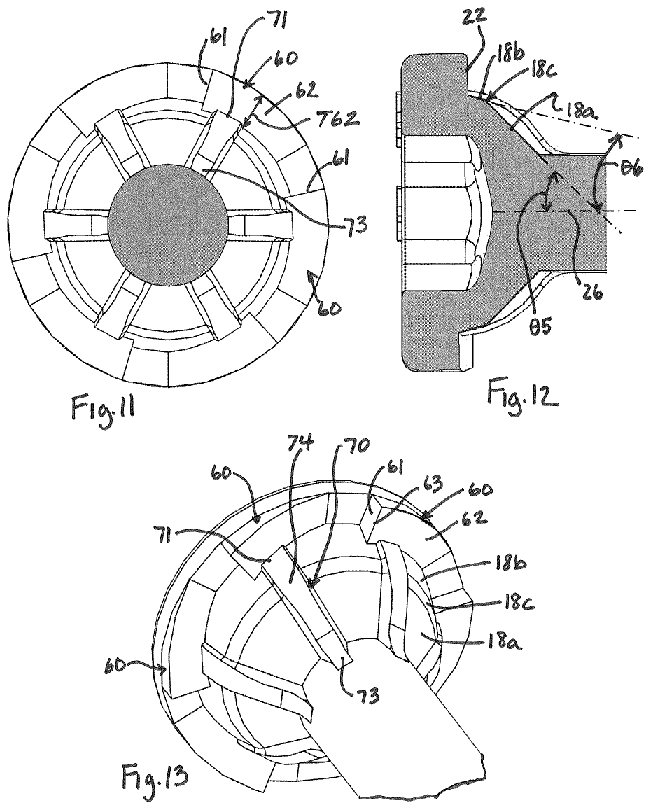

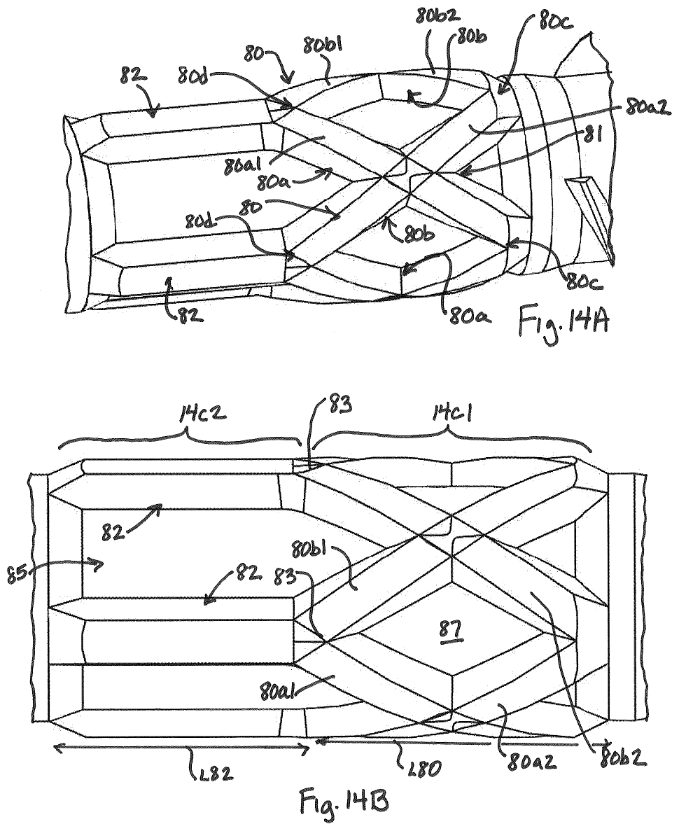

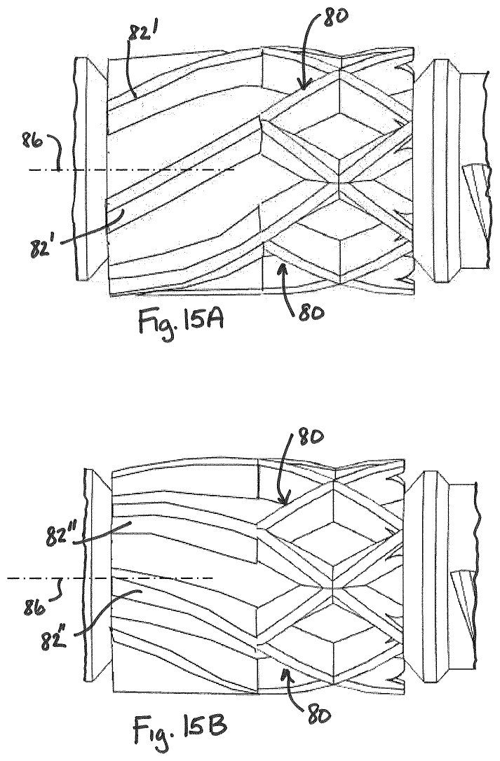

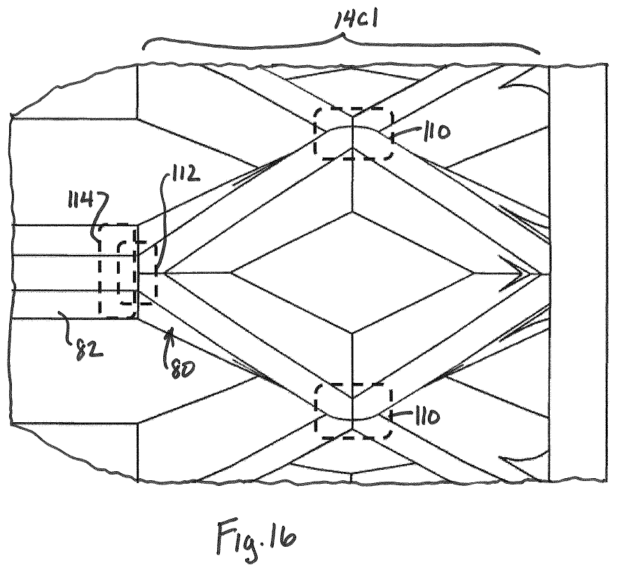

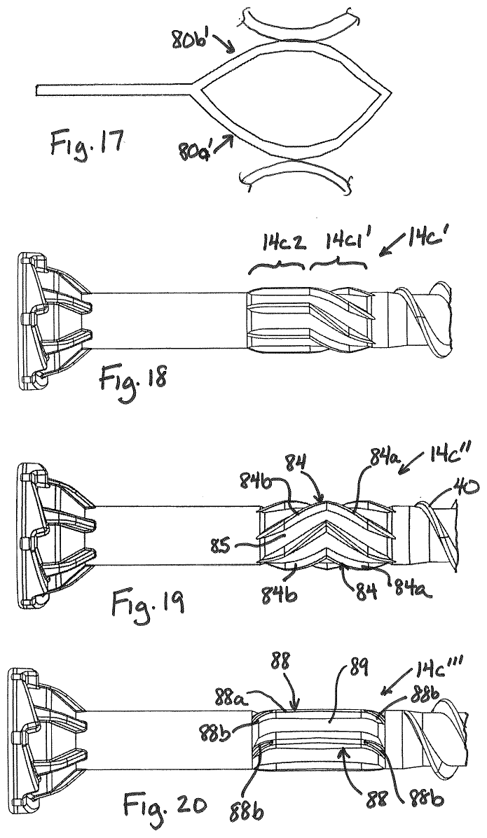

Referring to FIGS. 1-14B, one embodiment of a wood screw 10 is shown. The wood screw includes a head end 12, a shank or core 14 and a tapered end 16, with the head end 12 at one end of the shank 14 and the tapered end 16 at the opposite end of the shank 14 and terminating in a pointed tip. As used herein, the term shank refers to the elongated core or shaft of the screw, which can include threaded and unthreaded portions or segments. The tip angle or point angle α1 may be between nineteen degrees and twenty-three degrees.

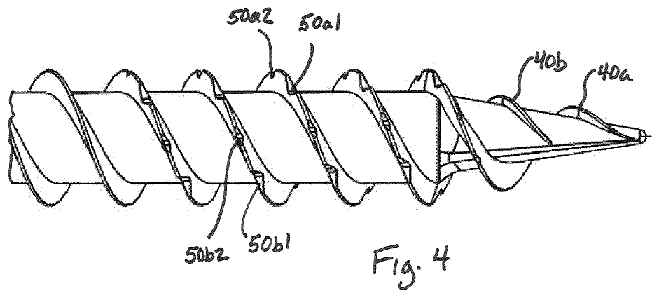

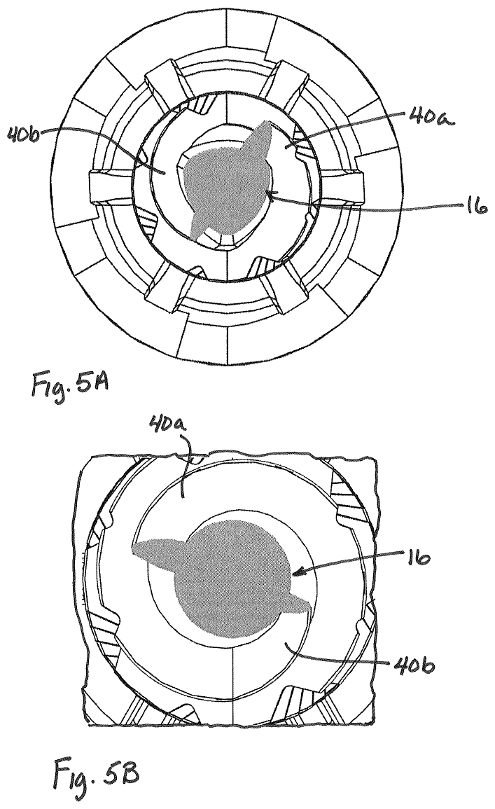

The head end 12 includes a neck section 18 running from the end of the shank to a head cap 20, where the neck includes frustoconical segments 18a and 18b. A chamfer or curved segment 18c may form the transition between segments 18a and 18b. The head cap 20 defines an annular ledge 22 facing the tapered end 16 and lying in a plane 24 that is perpendicular to a central axis 26 of the shank 14. An end face of the head cap includes a tool engaging part 28, here in the form of a drive recess with radially outward extending drive lobes 28a. The head cap 20 includes a thickness or axial depth d20, and the outer surface of the head cap may be cylindrical or slightly frustoconical. The core of the tapered end 16 of the screw may be out of round in cross-section, per the tri-lobular shape of FIG. 5A. Alternatively, the core of the tapered end 16 may be round in cross-section per FIG. 5B.

The shank 14 includes threaded axial segment 14a and an unthreaded axial segment 14b, as well as an intermediate reaming section 14c. Here, the diameter of unthreaded axial segment 14b is slightly larger than a diameter of the threaded axial segment 14a. A thread 40 is formed along the shank, and begins on the tapered end 16, extends onto the shank 14 and terminates at an axial location 42 that is spaced from the head end 12. Advantageously, the thread 40 is a multiple start thread (aka multiple lead thread), here a dual start thread, formed by a pair of helical threads 40a and 40b. The helical threads 40a and 40b are of similar configuration, but are rotationally offset from each other by one-hundred eighty degrees, with thread 40a starting at or adjacent to the tip of the screw and with thread 40b starting at a location spaced axially from the tip of the screw (by the pitch distance P) but, here, still on the tapered end 16, with the start location of thread 40b is in circumferential alignment with the start location of thread 40a. Variations where the threads 40a and 40b both start near the tip of the screw are also possible. The description below regarding the configuration of helical thread 40a is understood to equally apply to the helical thread 40b.

The helical thread 40a includes a leading flank 44a, a trailing flank 45a and a peripheral edge 46a joining the leading flank and the trailing flank. The helical thread 40a includes an initial axial segment 48a, comprising multiple thread turns, and along which the peripheral edge 46a includes a plurality of notches 50a, and a following axial segment 52a, comprising multiple thread turns, and along which the peripheral edge 46a lacks any notches. The initial segment 48a begins on the tapered end 16 and runs to an axial location 54 along the shank 14 that is between the tapered end 16 and the axial location 42. The helical thread 40a is an asymmetric angle thread, with a total thread angle θ1 of between twenty-five degrees and thirty-five degrees (e.g., between 27 degrees and 31 degrees, such as between 28 degrees and 30 degrees). By way of example, the trailing flank angle θ1a may be smaller than the leading flank angle θ1b (e.g., θ1a/θ1b=0.35 to 0.55). In some embodiments, the angle of the thread could be symmetric (e.g., trailing flank angle same as leading flank angle).

The helical threads 40a, 40b include a major diameter DM, a minor diameter Dm, a pitch P and a lead L. Because thread 40 is a dual start thread, the lead L of the thread is twice the pitch P. In exemplary embodiments, the screw threads include the dimensions according to Table 1 below.

TABLE 1
Exemplary Screw Thread Dimensions
(All dimensions in inches)

| Example # | DM | Dm | P | L |
|---|---|---|---|---|
| 1 (#12) | 0.231-0.241 | 0.149-0.159 | 0.124-0.134 | 0.248-0.268 |
| 2 (#10) | 0.193-0.203 | 0.128-0.138 | 0.105-0.115 | 0.210-0.230 |
| 3 (#9) | 0.175-0.185 | 0.117-0.127 | 0.095-0.105 | 0.190-0.210 |
| 4 (#8) | 0.157-0.167 | 0.100-0.110 | 0.085-0.095 | 0.170-0.190 |
| 5 (#6) | 0.147-0.157 | 0.090-0.100 | 0.062-0.072 | 0.124-0.144 |

With respect to the notching on the initial axial segment of each helical thread 40a, 40b (e.g., the notches along initial axial segment 48a of thread 40a), the notches are of two different types. In the illustrated embodiment, first notches 50a1 have a radial depth d1 that is greater than a radial depth d2 of the second notches 50a2 (e.g., d2/d1=0.45 to 0.65, such as 0.55 to 0.65), and the angle θ2 defined by the sides of the first notches 50a1 may be slightly greater than the angle θ3 defined by the sides of the second notches 50a2 (e.g., θ3/θ2=0.85 to 0.95). Here, each thread turn of the initial axial segment includes more first notches 50a1 than second notches 50a2 (e.g., four first notches 50a1 and three second notches 50a2), where the first and second notches alternate with each other around the thread, except for thread segments (e.g., 40a1) where two first notches 50a1 do not have any second notch therebetween, as a result of the lesser number of second notches 50a2. As used herein, the term “thread turn” refers to a helical extent of the thread that moves angularly through three-hundred sixty degrees about the central axis 26.

As mentioned above, the head end 12 includes a neck section 18 with frustoconical segments 18a and 18b and the head cap 20 defines an annular ledge 22 facing the tapered end 16 and lying in a plane 24 that is perpendicular to a central axis 26 of the shank 14. Here, frustoconical segment 18a runs at an angle or encloses an angle θ5 relative to the screw axis 26 and frustoconical segment 18b runs at an angle or encloses an angle θ6 relative to the screw axis, where θ5 is between thirty-five and fifty degrees (e.g., such as between thirty-seven and forty-three degrees), and θ6 is between ten and twenty degrees (e.g., such as between twelve and eighteen degrees). The smaller angle θ6 aids in a radially wider annular ledge or surface 22 (as compared to if frustoconical segment 18a extended all of the way to the head cap) to act as a bearing surface against pullout. In an alternative embodiment, frustoconical segment 18b could be cylindrical.

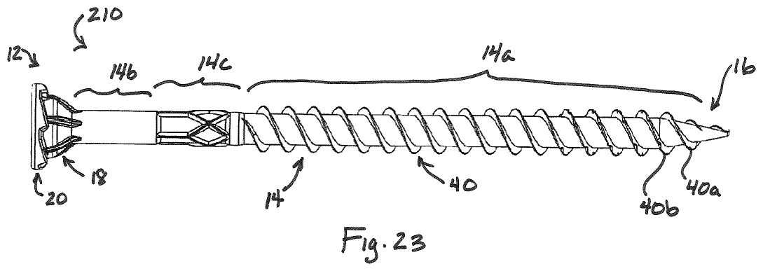

A series of repeating serrations 60 project from the annular ledge 22 toward the tapered end 16 and act as cutting teeth. In the illustrated embodiment, each serration 60 includes a leading face 61 that faces in the direction of rotational install and that runs substantially radially outward from frustoconical segment 18b and may run substantially parallel to the axis of the screw (e.g., lying in a plane in which the screw axis runs). Tooling constraints may result in the face 61 being offset from parallel to the screw axis by as much as five to ten degrees. In other embodiments, the leading face may run substantially perpendicular to the trailing face 62 of the serration. In such a case, and as indicated in FIG. 23, if the serration lead angle defined by the trailing face 62 (see θ4a below) is between fifteen and twenty degrees, the leading face 61 may be offset from parallel to the screw axis 26 by an angle that is substantially the same θ4a. The leading face 61 creates a cutting tooth and, together with trailing face 62, forms a cutting edge 63 on the serration. Embodiments in which the leading face is rotated slightly, so that the radially inner side of the leading face trails the cutting edge 63, per line 65, are also possible, to create a more prominent cutting tooth.

Spacing between the serrations exposes regions of the annular ledge 22. The trailing face 62 of each serration tapers toward the annular ledge or surface 22 at a serration lead angle θ4a and serration helix angle θ4b, taken at the outside diameter of the serration, that approximates the lead angle or pitch angle θ7a and helix angle θ7b of the screw thread, where the thread lead angle and helix angle are taken at the radially outer edge of the screw thread. An angle θ4a that is equal to the angle θ7a provides maximum wood contact under the head that is nearly perpendicular to the screw axis 26 for solid seating of the screw. More specifically, the screw is drawn into the wood at a rate such that the trailing face 62 will substantially follow the cut made by the cutting edge 63. An angle θ4a that is slightly less than the angle θ7a will cause the trailing face 62 to slightly compress the wood substrate surface cut by the cutting edge 63. An angle θ4a that is slightly more than the angle θ7a will enable the trailing face 62 allow slight re-expansion of the wood substrate surface cut by the cutting edge 63. Embodiments in which θ4a=θ7a±12% (such as θ4a=θ7a±10%), and likewise θ4b=θ7b±12% (such as θ4b=θ7b±10%), are preferred, though variations are possible.

In embodiments, the helix angle θ7b is between sixty-five and eighty degrees (e.g., such as between seventy and seventy-five degrees), which, in combination with the dimensions specified in Table 1 above, has been found to be beneficial in terms of reducing required energy to drive the screw and at the same time providing good pull-out resistance. Moreover, each of the threads 40a and 40b are configured such that, at the start end of the thread on the tapered end 16, the radially outer thread edge is low and rapidly rises to its full height to provide a faster start of thread action with the wood. Here, the full thread height is reached within less than seventy percent of one thread turn (e.g., such as within less than sixty percent of one thread or within less than fifty percent of one thread turn). Notably, each thread 40a and 40b is continuous on the tapered end as it transitions to full thread height because there is no cut on the tapered end that breaks the thread.

In embodiments, the height or axial length L61 of each serration 60 is defined as a function of the number of serrations and the pitch P of the screw. More specifically, embodiments in which L61=P/N60±20% (such as L61=P/N60±15%) are preferred, though variations are possible, where N60 is the number of serrations 60. Generally, the axial length L61 of each serration may be between about 0.0275 inches and about 0.0285 inches, and a ratio of the axial length L61 to the head axial depth d20 is between about 0.68 and 0.75. However, variations are possible, including a range of between 0.45 and 0.75.

Here, each serration 60 includes an associated nib 70 that runs in an axial direction from the trailing face 62 and onto the shank 14. Notably, each nib 70 is aligned with a respective one of the radially outwardly extending drive lobes 28a, such that the head end 71 of each nib provides added strength in the vicinity of the drive lobe 28a, via increased material thickness adjacent the drive lobe 28a. Here, each nib 70 is positioned at a location that, relative to the rotational install direction of the screw, rotationally trails the leading face 61 of its respective serration 60, but embodiments in which the nib is aligned with or leads the face 61 are possible. The head end 71 of each nib joins with the trailing face 62 at a location that is radially inward of the radially outer edge of the trailing face 62, such that the nib does not excessively interfere with the function of the trailing face as it enters the wood material. Here, at least fifty percent (e.g., at least sixty percent or at least seventy percent or at least eighty percent) of the radial thickness T62 of the trailing face 62, at locations circumferentially aligned with the nib 70, remains exposed (that is, remains clear of (i.e., is not connected to) the nib). Here, a depth or height of each nib 70 decreases when moving from the shank end 73 toward the head end 71, and a width of each nib 70, measure at its outer face 74, increases when moving from the shank end 73 toward the head end 71. Here, the shank end 73 is filleted for joinder to the shank 14, but embodiments without such fillets are possible.

Embodiments in which the nibs 70 do not meet with the serrations (e.g., where each nib terminates in the vicinity of region 18c) are possible.

The reaming section 14c of the screw shank includes a unique projection configuration, formed here by a segment 14c1 having a set of circumscribing diamond projections 80 from which straight projections 82 extend to form a segment 14c2. Each diamond projection 80 includes a rotationally leading wedge section 80a, which points in the direction of rotational install, and a rotationally trailing wedge section 80b, which points opposite the direction of rotational install. The rotationally leading side or point of each rotationally leading wedge section 80a abuts or is joined to the rotationally trailing side or point of the rotationally trailing wedge section 80b of the rotationally preceding diamond-shaped projection, per regions 81. For each diamond projection 80, the rotationally trailing side or open side of the rotationally leading wedge section 80a abuts or is joined to the rotationally leading side or open side of the rotationally trailing wedge section 80b, per regions 83.

Here, each rotationally leading wedge section 80a is formed by converging and intersecting walls 80a1 and 80a2, which may run helically, and each rotationally trailing wedge section 80b is formed by converging and intersecting walls 80b1 and 80b2, which may run helically, where the walls 80a1, 80a2, 80b1 and 80b2 are collectively oriented to define a diamond shape. The internal region 87 of each diamond projection is recessed relative to the walls forming the diamond-projection. In the illustrated embodiment, each straight projection 82 connects to a respective diamond projection 80 and extends substantially parallel to the axis 26 of the screw 10 and toward the head end of the screw. The alternating pattern of rotationally leading wedge sections 80a and rotationally trailing wedge sections 80b provides advantageous cutting of material during screw installation, and the immediately adjacent straight projections 82 form intermediate pocket regions 85 for handling of material that is cut, to reduce potential resistance to install as a result of cut material binding against the screw. Here, a series of four diamond projections 80 about the circumference of the screw are provided, but the number could vary (e.g., 3 or 5 or 6 or 7 or 8). Here, the length L80 of the diamond projection portion of the reaming section is comparable to the length L82 of the straight projection portion of the reaming section (e.g., L80=L82±35%), but variations are possible. For example, variations in which L80/L82=1.4 to 1.5 are contemplated as potentially beneficial.

Notably, the diamond projection configuration also results in a circumferential series of axially leading wedge sections 80c, which point toward the tip end of the screw, and a circumferential series of axially trailing wedge sections 80d, which point toward the head end of the screw. The open side of each axially leading wedge section 80c abuts against the open side of one of the axially trailing wedge sections 80d. Here, each axially leading wedge section 80c is formed by converging and intersecting walls (e.g., 80a2 and 80b2), and each rotationally trailing wedge section 80b is formed by converging and intersecting walls (e.g., 80b1 and 80a1).

It is to be clearly understood that the above description is intended by way of illustration and example only, is not intended to be taken by way of limitation, and that other changes and modifications are possible.

Referring to FIGS. 15A and 15B, alternative embodiments of the reaming section are shown, in which the projections 82′, 82″ extending from the diamond projections are skewed relative to the axis 86 of the screw. Here, projections 82′ run from the diamond projections 80 toward the head of the screw and in a direction that is with the rotational install direction of the screw, and the projections 82″ run from the diamond projections 80 toward the head of the screw and in a direction that is counter to the rotational install direction of the screw. The general path of the projections 82′ and 82″ may be a helical path.

Referring to FIG. 16, embodiments in which dashed regions 110 or 112 are slightly recessed relative to the surrounding projection walls, or slightly raised relative to the surrounding projection walls are possible. In both such cases, the projection walls are still interconnected. Moreover, embodiments in which dashed region 114 is provided without any projection wall, to provide a slight gap between the diamonds 80 and the straights 82, are also possible, and in such cases the straights 82 would still be deemed to extend from the first segment 14c1 toward the head end.

Embodiments in which the rotationally leading and trailing wedge sections 80a′ and 80b′ are more curved, such that the apexes of each leading and trailing wedge are curved, are also possible, as schematically indicated in FIG. 17. In another variation, the rotationally leading and trailing wedge sections 80a″ and 80b″ include a short linear region at the locations 81 where the apexes of the wedge sections meet, per FIG. 17A.

Per FIG. 18, a reaming section 14c′ in which the axially leading segment 14c1′ of the reaming section includes only helically extending projections 186, running in the direction of rotational install when moving from segment 14c2 toward the tapered end of the screw, are possible. Segment 14c2 includes linear or substantially linear running projections, which run substantially parallel to the screw axis.

Per FIG. 19, a reaming section 14c″ in which all projections 84 are formed as trailing wedges, with circumferential spacing 85 therebetween (such that the projections do not contact each other), is also possible. Here, axially leading portions 84a of the projections run helically in the same direction as the screw thread 40, and axially trailing portions 84b of the projections run helically in the opposite direction.

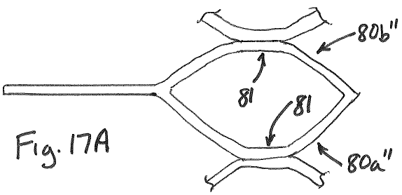

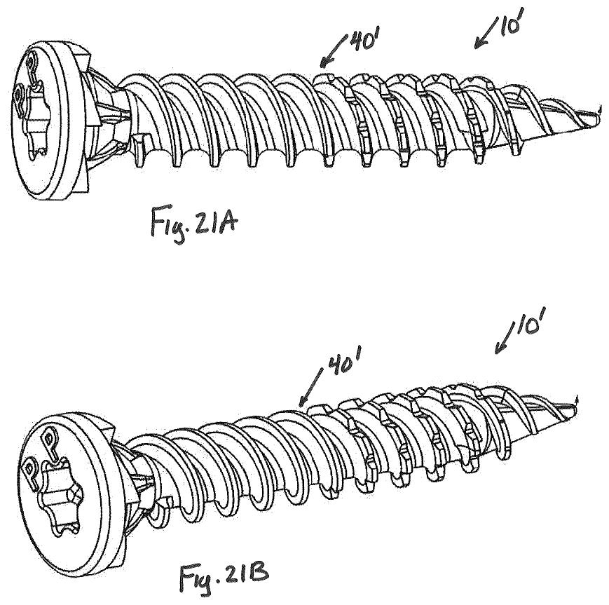

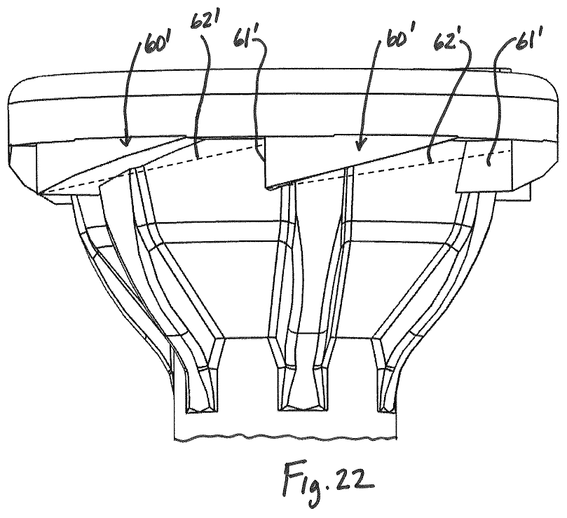

Per FIG. 20, a reaming section 14c′″ in which all projections 88 are arch-shaped, with arch top wall portions 88a, which here run substantially parallel to the screw axis. Each arch top wall portion 88a interconnects arch sidewall portions 88b that both extend away from the arch top wall portion 88a and in the direction of rotational install, with the open side 88c of the arch-shape facing in the rotational install direction, and with a circumferential spacing 89 between the projections, is also possible.

Per FIGS. 21A and 21B, embodiments in which the reaming section of the screw is absent are possible. Here, screw 10′ includes a thread 40′ comparable to the thread of screw 10 described above, except that the thread 40′ extends all the way to the neck section of the screw. The screw 10′ also includes serrations and nibs similar to that described above for screw 10.

Per FIG. 22, in an alternative embodiment of the head, the serrations 60′s may be configured such that the trailing face 62′ (represented in dashed line form) of each serration extends all the way to the leading face 61′ of the following serration (relative to the rotational install direction). In such a configuration, the annular face at the underside of the head would, effectively be eliminated in its entirety.

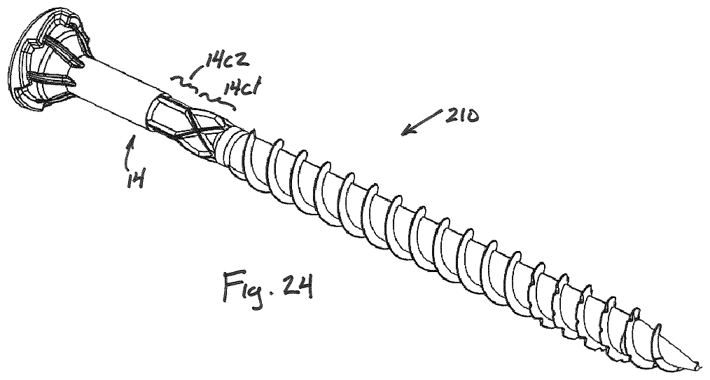

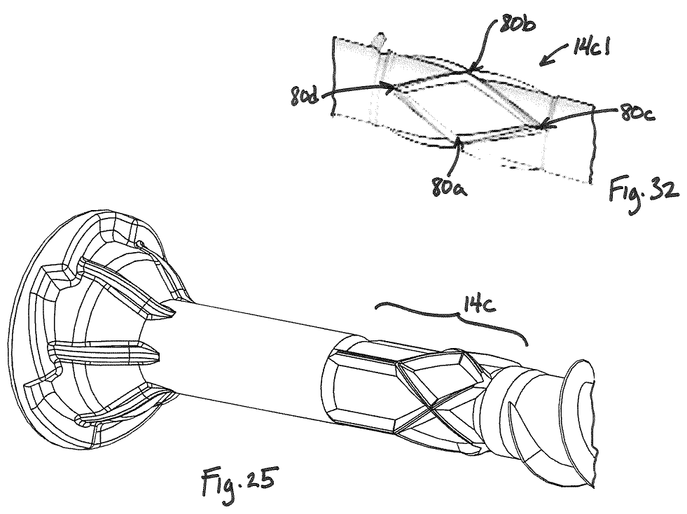

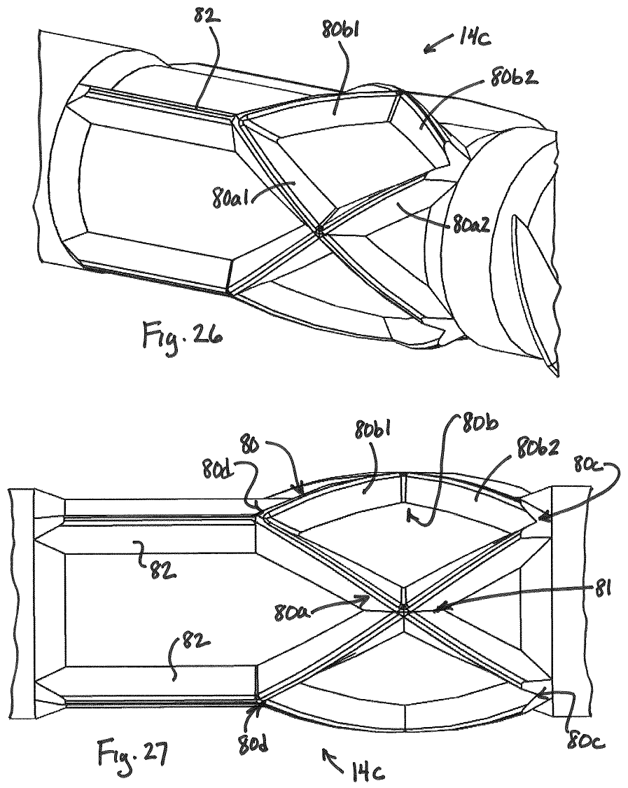

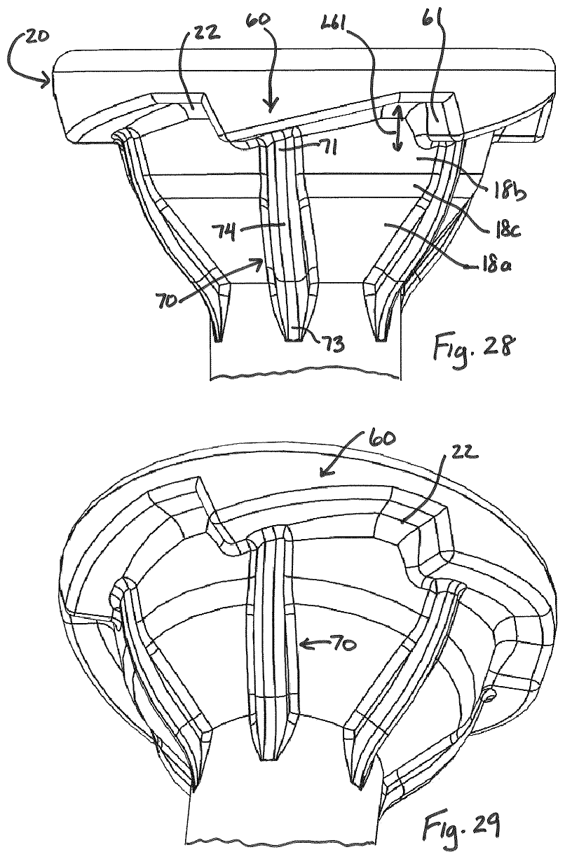

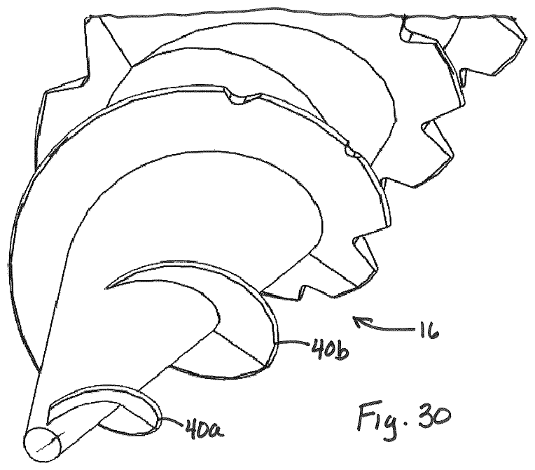

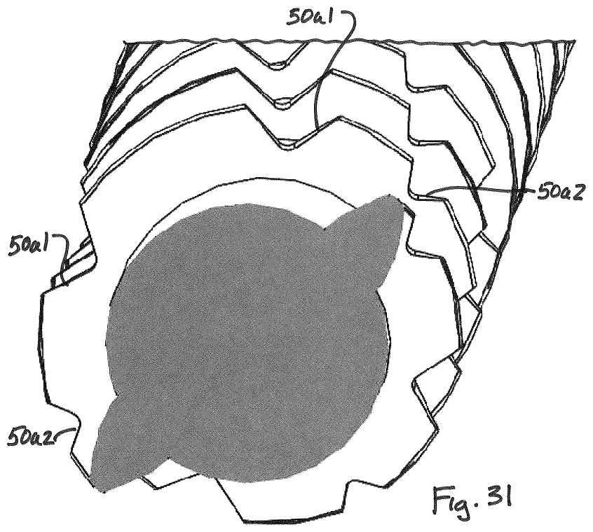

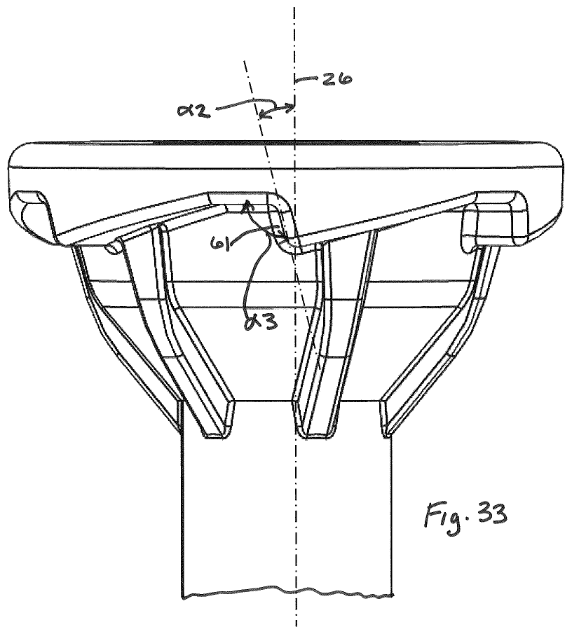

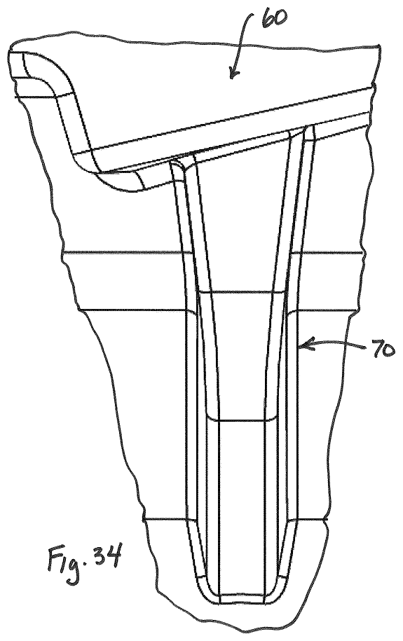

Referring to FIGS. 23-31 and 33-34, a screw 210 is shown, which is very similar to above-described screw 10, with like numerals depicting like parts. Except as otherwise specified, the features of screw 210 are the same as screw 10 described above. Screw 210 is slightly more refined than screw 10 in the reaming section 14c and the head nib section. In particular, the projections (e.g., 80a1, 80a2, 80b1, 80b2 and 82) in the reaming section 14 have distal edges that are slightly curved and/or or have only a very small flat at the top. Embodiments in which the distal edges are sharper (e.g., no curve or flat) are also possible. Similarly, the contour and shape of the nibs 70 at the underside of the head cap 20 are more tapered on the leading and trailing sides than in the case of screw 10. Here, the leading face 61 of each serration is angularly offset from the screw axis 26 by an angle α2 of between about ten and thirty degrees (e.g., between ten and twenty degrees), such that the leading face encloses an obtuse angle α3 (of between about one-hundred and one-hundred twenty degrees (e.g., between one-hundred and one-hundred ten degrees) with the annular ledge 22.

Referring to FIG. 32, an alternative reaming section is shown and is made up of only segment 14c1. In such embodiments, the axial length of segment 14c1 may, in some cases, be lengthened, to result in the configuration shown in FIG. 32, with a pattern of rotationally leading wedge projections 80a and rotationally trailing wedge projections 80b, and axially leading wedge projections 80c opposite axially trailing wedge projections 80d.

Embodiments in which any reaming section described above is implemented on a screw with a single lead thread, are also contemplated.

Some aspects (A #) are indicated below.
A1. A wood screw, comprising: a head end, a shank and a tapered end, the head end including a tool engaging part, the head end located at a first end of the shank and the tapered end located at a second end of the shank; a thread formed along the shank, wherein the thread begins on the tapered end, extends onto the shank and toward the head end; and wherein the head end includes a neck running from the first end of the shank to a head cap, wherein the head cap includes an underside facing the tapered end and defining an annular ledge, wherein the underside includes a plurality of serrations extending from the annular ledge, each serration having a leading face and a trailing face that define a cutting edge, wherein the trailing face of each serration tapers away from the tapered end and into the annular ledge.
A2. The wood screw of A1, wherein the underside of the head cap defines an annular ledge facing the tapered end and lying in a plane that is perpendicular to a central axis of the shank, wherein the plurality of serrations are spaced apart along the annular ledge, wherein the trailing face of each serration tapers into the annular ledge.
A3. The wood screw of A2, wherein the trailing face of each serration tapers toward the annular ledge at an angle, relative to the plane, that is within ±10% of a pitch angle defined by the thread.
A4. The wood screw of A3, wherein the head cap has an axial depth and each serration has a maximum axial projection dimension away from the annular ledge, wherein a ratio of the maximum axial projection dimension to the axial depth is between about 0.68 and 0.75.
A5. The wood screw of A3, wherein the head cap has an axial depth and each serration has a maximum axial projection dimension away from the annular ledge, wherein the maximum axial projection dimension is between 0.0275 inches and 0.0285 inches.
A6. The wood screw of A1, wherein the head end further includes a plurality of nibs running from the shank and along the neck toward the serrations.
A7. The wood screw of A6, where each nib runs substantially parallel to a central axis of the screw and abuts the trailing face of one of the serrations.
A8. The wood screw of A6, wherein each nib abuts the trailing face of one of the serrations and is configured such that at least fifty percent of a radial thickness of the trailing face in alignment with the nib remains exposed.
A9. The wood screw of A2, wherein the head cap has an axial depth and each serration has a maximum axial projection dimension away from the annular ledge, wherein a ratio of the maximum axial projection dimension to the axial depth is between about 0.68 and 0.75.
A10. The wood screw of A2, wherein the thread is a dual start thread formed by a first thread and a second thread, wherein the first thread begins on the tapered end and the second thread begins on the tapered end, wherein the second thread begins on the tapered end and is rotationally offset from the first thread by one-hundred eighty degrees.
A11. The wood screw of A10, wherein a height of the first thread transitions from a starting height to its full thread height within less than seventy percent of one thread turn, and the height of the second thread transitions from a starting height to its full thread height within less than seventy percent of one thread turn.
A12. The wood screw of A11, where the first thread is continuous in a helical extent of transition between its start height and its full thread height, and the second thread is continuous along a helical extent of transition between is start height and its full thread height.
A13. The wood screw of A1, wherein the thread includes a peripheral edge, and an initial axial segment comprising multiple thread turns and along which the peripheral edge includes a plurality of notches, and a following axial segment comprising multiple thread turns and along which the peripheral edge lacks any notches, wherein the plurality of notches along the initial axial segment includes first notches having a first radial depth and second notches having a second radial depth that is less than the first radial depth.
A14. The wood screw of A1: wherein the thread terminates at a first axial location along the shank that is spaced from the head end; wherein a reaming section is located along the shank and runs from proximate to the first axial location and toward the head end, the reaming section including projections thereon, wherein the reaming section comprises a first segment with a repeating pattern of rotationally leading wedge projections alternating with rotationally trailing wedge projections.
A15. The wood screw of A14, wherein the reaming section further comprises a second segment with (i) a set of circumferentially spaced apart linear projections extending from the first segment toward the head end or (ii) a set of circumferentially spaced apart helical projections extending from the first segment toward the head end.
A16. The wood screw of A14, wherein the repeating pattern of rotationally leading wedge projections and rotationally trailing wedge projections are formed by a set of circumscribing diamond-shaped wall projections that collectively define a recessed diamond-shape internally of the walls.
A17. The wood screw of A14, wherein: each rotationally leading wedge projection is curved at its apex and each rotationally trailing wedge projection is curved at its apex; or each rotationally leading wedge projection includes a linear part at its apex and each rotationally trailing wedge projection includes a liner part at its apex.
A18. The wood screw of A1, wherein the thread terminates at a first axial location along the shank that is spaced from the head end; wherein a reaming section is located along the shank and runs from proximate to the first axial location and toward the head end, the reaming section including projections thereon, wherein the reaming section comprises: an axially leading segment and an axially trailing segment, wherein the axially leading segment includes only helically running projections, running in a direction of rotational install when moving from the axially trailing segment toward the tapered end, wherein the axially trailing segment includes a set of circumferentially spaced apart linear projections extending from the axially leading segment toward the head end; or a set of circumferentially spaced apart projections each formed as a trailing wedge that has its apex facing or pointing in a direction opposite a direction of rotational install, with circumferential spacing therebetween such that the projections do not contact each other; or a set of circumferentially spaced apart arch-shaped projections, with spaced apart sidewall portions interconnected by a substantially linear portion, with an open side of each arch-shaped projection facing in a direction of rotational install.
A19. A wood screw, comprising: a head end, a shank and a tapered end, the head end including a tool engaging part, the head end located at a first end of the shank and the tapered end located at a second end of the shank; a thread formed along the shank, wherein the thread begins on the tapered end, extends onto the shank and toward the head end; and wherein the thread includes a peripheral edge, and an initial axial segment comprising multiple thread turns and along which the peripheral edge includes a plurality of notches, and a following axial segment comprising multiple thread turns and along which the peripheral edge lacks any notches, wherein the plurality of notches along the initial axial segment includes first notches having a first radial depth and second notches having a second radial depth that is less than the first radial depth.
A20. The wood screw of A19, wherein an angle defined by sides of the first notches is greater than an angle defined by sides of the second notches.
A21. A wood screw, comprising: a head end, a shank and a tapered end, the head end including a tool engaging part, the head end located at a first end of the shank and the tapered end located at a second end of the shank; a thread formed along the shank, wherein the thread begins on the tapered end, extends onto the shank and toward the head end; and wherein the thread is a dual start thread formed by a first thread and a second thread, wherein the first thread begins on the tapered end and the second thread begins on the tapered end, wherein the second thread begins on the tapered end and is rotationally offset from the first thread by one-hundred eighty degrees.
A22. The wood screw of A21, wherein a height of the first thread transitions from a starting height to its full thread height within less than seventy percent of one thread turn, and the height of the second thread transitions from a starting height to its full thread height within less than seventy percent of one thread turn.
A23. The wood screw of A22, where the first thread is continuous in a helical extent of transition between its start height and its full thread height, and the second thread is continuous along a helical extent of transition between is start height and its full thread height.
A24. The wood screw of A23, wherein a helix angle of each of the first thread and the second thread is between sixty-five and eighty degrees.

Still other variations are possible.

1. A screw, comprising:
a head end, a shank and a tapered end, the head end including a tool engaging part, the shank having a central axis, the head end located at a first end of the shank and the tapered end located at a second end of the shank;
a thread formed along the shank, wherein the thread begins on the tapered end, extends onto the shank and toward the head end; and
wherein the head end includes a neck running from the first end of the shank to a head cap, wherein the head cap includes an underside facing the tapered end and defining an annular ledge, wherein the annular ledge faces the tapered end;
wherein the neck includes a first frustoconical segment running from the shank to an axial location spaced from the annular ledge, wherein the neck includes a second frustoconical segment running from the annular ledge toward the axial location;
wherein at least one of:
(i) the head end further includes a plurality of nibs running from the shank and along the neck toward the annular ledge, wherein each nib extends along regions of both the first frustoconical segment and the second frustoconical segment;
or
(ii) the first frustoconical segment encloses a first angle relative to the central axis, the second frustoconical segment encloses a second angle relative to the central axis, wherein the first angle is greater than the second angle.

2. The screw of claim 1, wherein both:
(i) the head end further includes the plurality of nibs running from the shank and along the neck toward the annular ledge, wherein each nib extends along regions of both the first frustoconical segment and the second frustoconical segment;
and
(ii) the first frustoconical segment encloses the first angle relative to the central axis, the second frustoconical segment encloses the second angle relative to the central axis, wherein the first angle is greater than the second angle.

3. The screw of claim 1 wherein the head end includes the plurality of nibs running from the shank and along the neck toward the annular ledge, wherein each nib extends along regions of both the first frustoconical segment and the second frustoconical segment, and wherein the underside includes a plurality of serrations extending from the annular ledge, and wherein each nib includes an end that abuts a respective one of the serrations.

4. A screw, comprising:
a head end, a shank and a tapered end, the head end including a tool engaging part, the shank having a central axis, the head end located at a first end of the shank and the tapered end located at a second end of the shank;
a thread formed along the shank, wherein the thread begins on the tapered end, extends onto the shank and toward the head end; and
wherein the head end includes a neck running from the first end of the shank to a head cap, wherein the head cap includes an underside facing the tapered end and defining an annular ledge, wherein the annular ledge faces the tapered end;
wherein the neck includes a first frustoconical segment running from the shank to an axial location spaced from the annular ledge, wherein the neck includes a second frustoconical segment running from the annular ledge toward the axial location;
wherein the head end further includes a plurality of nibs running from the shank and along the neck toward the annular ledge, wherein each nib extends along regions of both the first frustoconical segment and the second frustoconical segment;
wherein the underside includes a plurality of serrations extending from the annular ledge, wherein each serration extends along a portion of the second frustoconical segment, and wherein each nib includes an end that abuts a respective one of the serrations.

5. The screw of claim 4, wherein the first frustoconical segment encloses a first angle relative to the central axis, the second frustoconical segment encloses a second angle relative to the central axis, wherein the first angle is greater than the second angle.
